(19) United States
(12) Patent Application Publication
(10) Pub. No.: US 2014/0373689 A1
(43) Pub. Date: Dec. 25, 2014

(54) HAND TOOL JOINT

(71) Applicant: COLTENE WHALEDENT INC., Cuyahoga Falls, OH (US)

(72) Inventors: Peter Sildve, Akron, OH (US); Terry Mustard, Cuyahoga Falls, OH (US)

(21) Appl. No.: 14/369,018

(22) PCT Filed: Jan. 10, 2013
(86) PCT No.: PCT/US2013/020957

§ 371 Date: Jun. 26, 2014

Related U.S. Application Data
(60) Provisional application No. 61/585,014, filed on Jan. 10, 2012.

(51) Int. Cl. B25B 7/08; B25B 7/02

(52) U.S. Cl. CPC B25B 7/08; B25B 7/02
USPC 81/416

(57) ABSTRACT

Disclosed herein is a hand tool comprising a first hand tool member comprising a pin, a hole, a bearing surface, and at least one groove, and a second hand tool member comprising a hole, a bearing surface, and at least one groove. The groove of the first hand tool member engages the groove of the second hand tool member when the hand tool is in a closed position. Further, the groove of the first hand tool member disengages from the groove of the second hand tool member when the hand tool is in a fully open position.

### CROSS REFERENCE TO RELATED APPLICATIONS

The present application claims priority to U.S. Provisional Application No. 61/585,014, filed Jan. 10, 2012, the entire content of which is incorporated by reference in its entirety

### FIELD OF THE INVENTION

The invention is directed to a mechanical joint for hand tools such as pliers or the like.

### BACKGROUND OF THE INVENTION

Hand tools typically employ two types of pivot joints: lap joints and box joints. In both types of joints, no more than fifty percent of the cross--sectional area of at least one of the jaws is available to resist the strain put upon the hand tool when in use, Depicted in FIG. 1 is a hand tool (100) having a lap joint, wherein each half of the hand tool (101, 102) is joined by at an overlapping region having a. recess (103, 104). For example, each half of the hand tool (101, 102) may be machined to define a recess (103, 104) that is half the width of the hand tool. This produces a hand tool 100 having a combined thickness the same as each half of the hand tool (101, 102), Where the hand tool parts (101, 102) meet, they are joined by a rivet or screw (105).

The rivet in a lap joint tends to loosen with time and use, eventually making the hand tool unreliable. However, lap joints do not require a complicated or expensive manufacturing process compared to that of box joints.

In a hand tool (200) having a box joint, as depicted in FIGS. 2 and 3, each half of the hand tool (201, 202) surrounds the joint of the other half so that proper alignment of the hand tool (200) is maintained. In operation, box joints offer a larger hearing surface (203) than that of a box joint. However, hand tools with box joints are generally more expensive to produce than those with lap joints.

Additionally, a deficiency commonly shared by hand tools having either a lap joint construction or a. box joint is that the hand tool cannot be easily disassembled. This can be a detriment if the hand tool is intended for medical procedures where the hand tool needs to be sterilized.

Therefore, a need clearly exists for a joint construction design that provides the stability of a box joint with the ease of manufacturing of a lap joint with the added functionality of disassembly for sterilization.

### SUMMARY OF THE INVENTION

These and other needs are met by a hand tool of the present invention.

### BRIEF DESCRIPTION OF THE DRAWINGS

FIG. 1 depicts a prior art hand tool having a lap joint construction.

FIG. 2 and FIG. 3 depict a prior art hand tool having a box joint construction.

FIGS. 4A and 4B f front and rear views of a first hand tool component of the hand tool according to the present invention.

FIGS. 5A and 5B depicts rear and front views of a second hand tool component of the hand tool according to the present invention.

FIGS. 6 and 7 depict an exploded view of the hand tool of the present invention showing how the hand tool of the present invention is assembled.

FIG. 8 depicts the hand tool of the present invention after assembly in a closed position.

FIG. 9 depicts the hand tool of the present invention after assembly in an open position.

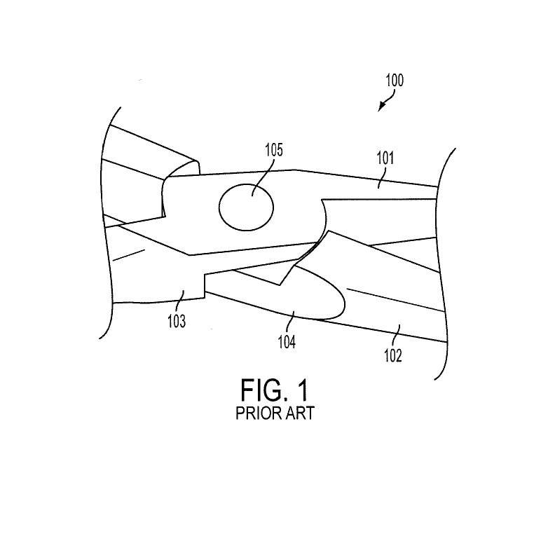

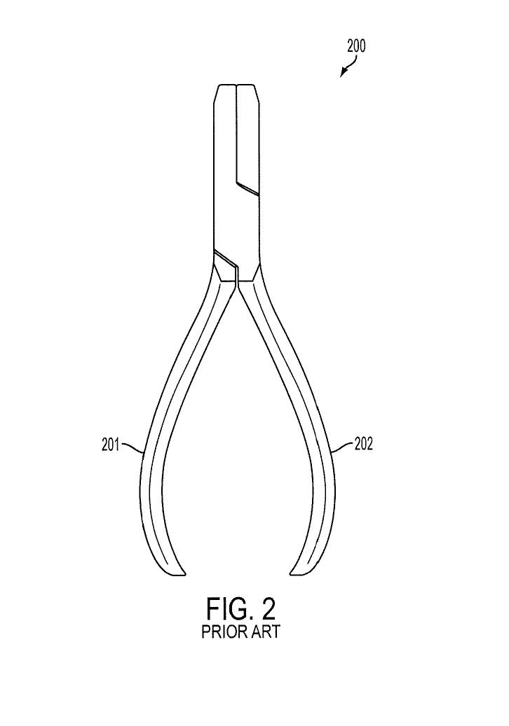

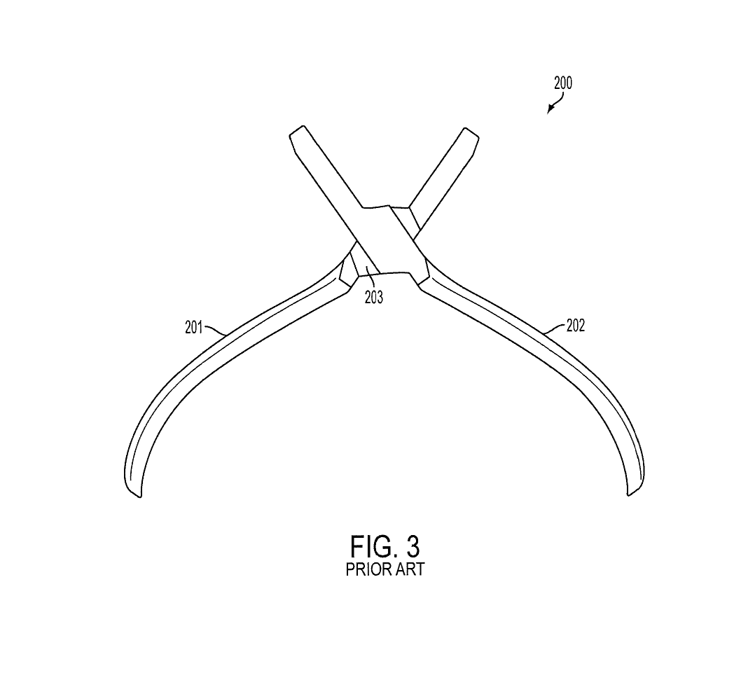

### DETAILED DESCRIPTION OF THE INVENTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. In the various views of the drawings, like reference characters designate like or similar parts.

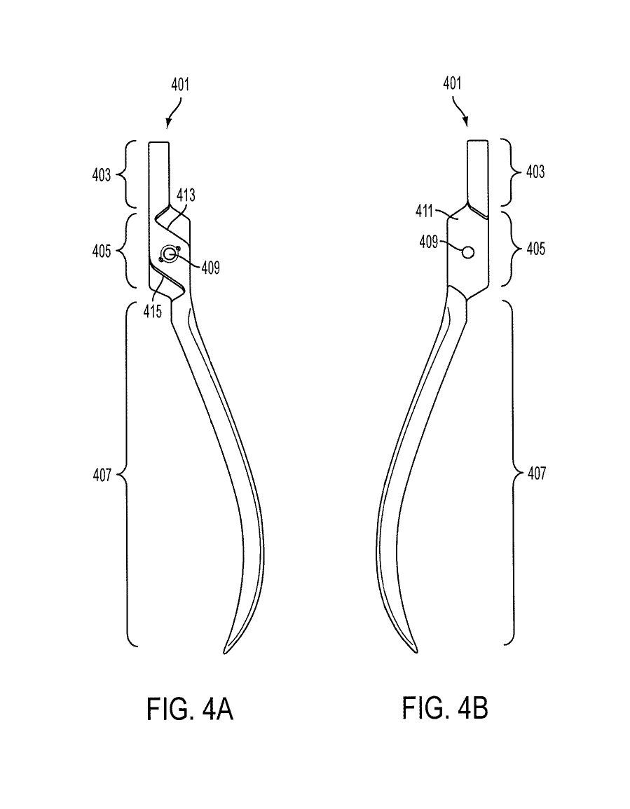

The components of the hand tool of the present invention will first be described in their unassembled configuration, With reference to FIGS. 4A and 4B, depicted is a first hand tool component (401) having a jaw portion (403), joint portion (405), and a handle portion (407). The joint portion (405) comprises a hole (409), a bearing surface (411), a first slot (413), and a second slat (415).

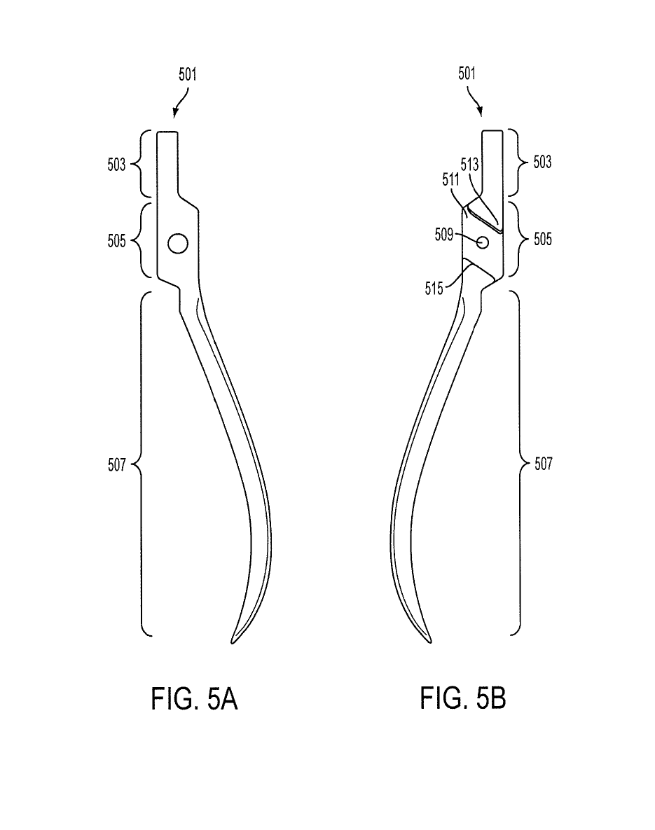

FIGS. 5A and 5B depict a second hand tool component (501) having a jaw portion (503), a joint portion (505), and a handle portion (507). The joint portion (505) comprises a pin (509), a bearing surface (511), a first slat (513), and a second slot (515).

The three portions of the first hand tool component (403, 405, 407) or of the second hand tool component (503, 505, 507) may be integrally formed or separately formed and then later joined. For example, first hand tool component (401) and second hand tool component (501) may be formed from various grades of metal dependent on the application, with the preferred metal being a structurally appropriate, corrosion resistant material, such as stainless steel. In some embodiments, the handle portions (407. 507) may contain a textured or rubberized surface to aid in gripping the hand tool.

Various manufacturing processes such as computer numerical control (CNC) machining, injection molding, casting, or forging may be used to form the first hand tool component (401) or the second hand tool component (501). For example, various grades of plastic can be used to form the first hand tool component (401) and the second hand tool component (501) using injection molding.

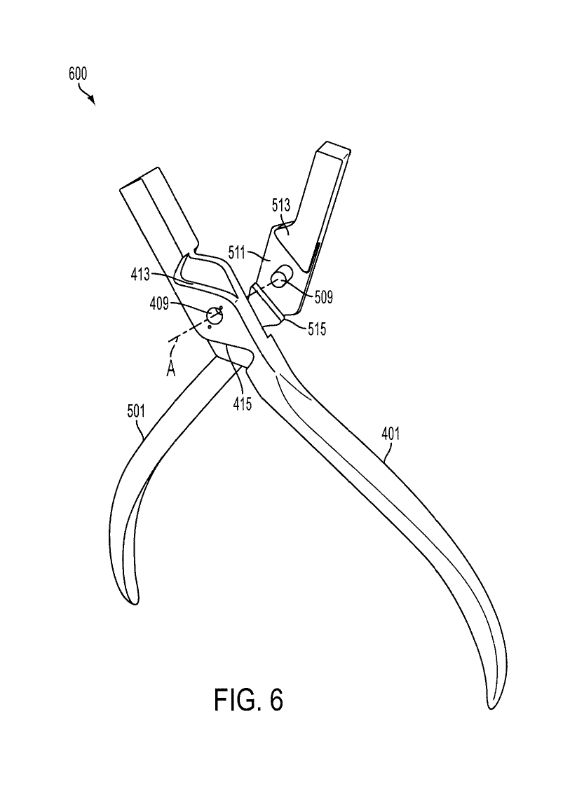

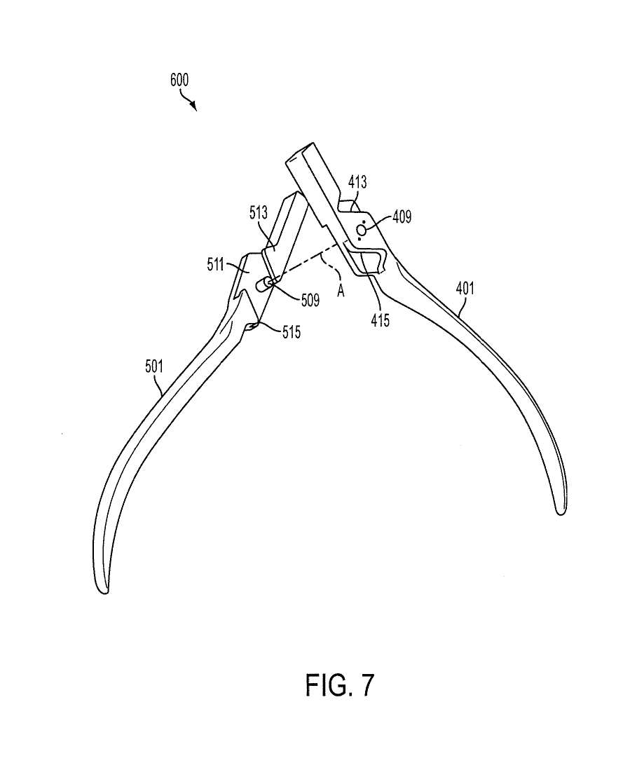

The assembly of the hand tool (600) from first hand tool component (401) and second hand tool component (501) is depicted in FIGS. 6 and 7. First hand tool component (401) and second hand tool component (501) are aligned as shown so that the pin (509) can be received in hole (409), thus defining a pivoting axis A about which first hand tool component (401) and second hand tool component (501) can pivot.

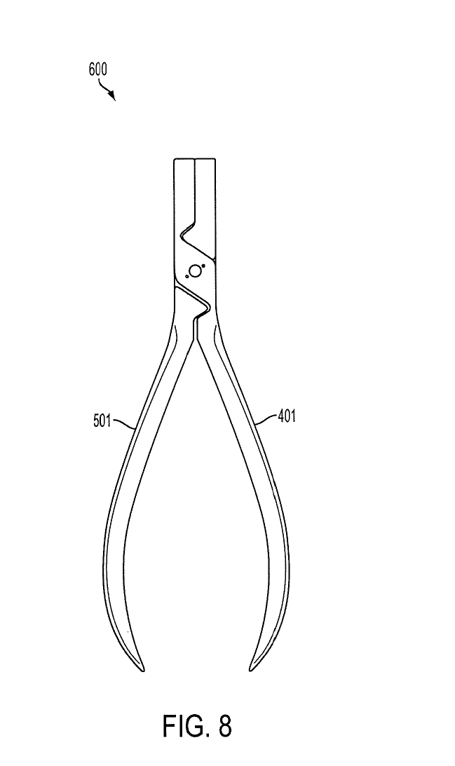

As first hand tool component (401) and second hand tool component (501) are advanced toward each other. the two bearing surfaces (411, 511) come into contact with each other and the pin (509) engages the hole (409). Then, as the two handle portions (407, 507) are advanced toward each other, the slots interlock (i.e. 413 with 513; 415 with 515). This prevents first hand tool component (401) from disengaging from second hand tool component (501) when the hand tool (600) is in any position except fully open and aids in resisting torsional stress when the hand tool (600) is in use. The hand tool (600) is depicted in a closed position in FIG. 8.

Due to its construction, the hand tool (600) provides the bearing surface and reduced wear of a box joint hand tool with the case of assembly and manufacturing of a lap joint hand tool. Additionally, the hand tool (600) can be disassembled for improved sterilization if it is being used in medical applications. In another embodiment, the hand tool (600) can permanently be fastened after assembly to provide extra strength, durability, and accuracy in tip alignment, For example, after the pin (509) is received in the hole (409), a fastening member can be added to the end of the pin (509) so that the first hand tool component (401) and the second hand tool component (501) can not be separated.

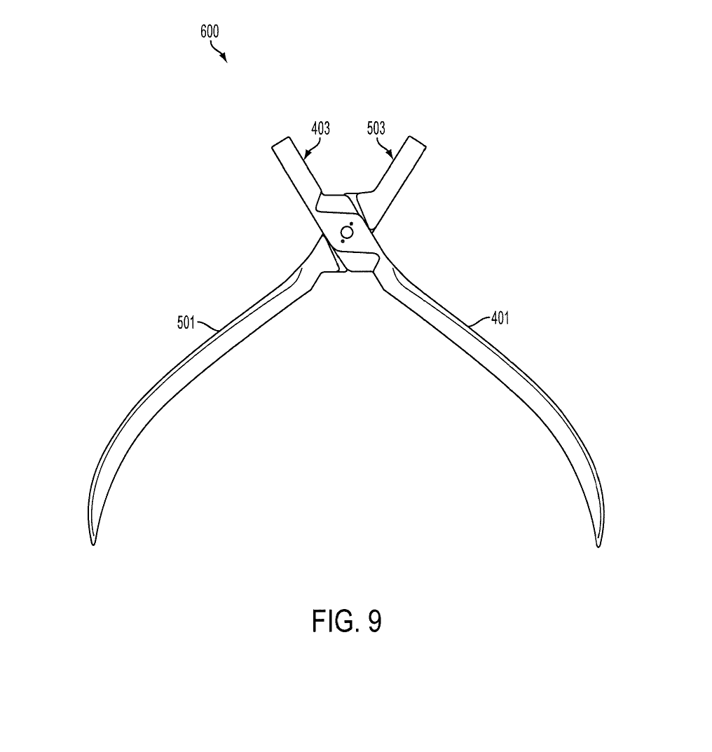

As shown in FIGS. 8 and 9, the hand tool (600) operates as a standard pair of pliers. However, the jaw portions (403, 503) may be altered based upon the desired usage of hand tool (600). For example, the jaw portions (403, 503) may be curved and meet at blunt ends if the hand tool (600) is used for tooth extraction. Some examples of shapes that jaw portions (403, 503) are intended to perform include a wide range of applications such as cutting, grasping and forming wires, etc. or for scraping encountered in dental and non-dental markets.

While the present invention has been described at some length and with some particularity with respect to the several described embodiments, it is not intended that it should be limited to any such particulars or embodiments or any particular embodiment, but it is to be construed to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A hand tool comprising:
a first hand tool member comprising a pin, a hole, a bearing surface, and at least one groove;
a second hand tool member comprising a hole, a bearing surface, and at at, least one groove,
wherein the groove of the first hand tool member engages the groove of the second hand tool member when the hand tool is in a closed position, and
wherein the groove of the first hand tool member disengages from the groove of he second hand tool member when the hand tool is in a fully open position.

2. The hand tool of claim 1. wherein the first hand tool member and second hand tool member are formed from various grades of metal or plastic.

3. The hand tool of claim I, wherein the first hand tool member and second hand tool member are formed using computer numerical control (CNC) machining, injection molding, casting, or forging.

4. The hand tool of claim wherein a pin attached to the first hand tool member engages the hole of the second hand tool member to define a pivot axis about which the first hand tool member and second hand tool member can pivot.

5. The hand tool of claim 4 wherein the hand tool is disassembled by pivoting the first hand tool member and second hand tool member until the hand tool is fully opened and disengaging the pin of the second hand tool member from the hole of the first hand tool member

6. The hand tool of claim 1, wherein a pin is inserted through the hole in the first hand tool member and the second hand tool member to define a pivot axis about which the first hand tool member and second hand tool member can pivot.

7. The hand tool of claim 1, wherein the first land tool portion further comprises a jaw portion and a handle portion, and
wherein the second hand tool portion further comprises a jaw portion and a handle portion.

8. The hand tool of claim 7, wherein the jaw portion of the first hand tool portion and the jaw portion of the second hand tool portion are in physical contact when the hand tool is in a closed position.

9. A hand tool comprising:
a first handle and a pivotally connected second handle, each of said first and second handles including a user rasping portion;
wherein the first handle terminates in an extending jaw;
wherein the second handle terminates in an opposing extending jaw; and
wherein the first handle comprises a tongue portion and the second handle comprises a groove portion;
wherein the tongue portion engages the groove portion when the hand tool is in a fully closed configuration and the tongue portion disengages from the groove portion when the hand tool is in a fully opened configuration.

10. The hand tool o c aim wherein the user grasping portion has a textured surface.

11. The hand tool of claim 9, wherein the user grasping portion has a rubberized surface.
